(19) United States
(12) Patent Application Publication
(10) Pub. No.: US 2007/0107581 A1
(43) Pub. Date: May 17, 2007

(54) Method and system for increasing musician comfort

(76) Inventor: Greg Allen, Dayton, OH (US)

Correspondence Address: Mr. Greg Allen, 228 South Westview Avenue, Dayton, OH, 45403, US

(21) Appl. No.: 11/580,759

(22) Filed: Oct. 13, 2006

Related U.S. Application Data
(60) Provisional application No. 60/736,160, filed on Nov. 14, 2005.

(51) Int. Cl. G10G 5/00; G10D 3/00

(52) U.S. Cl. 84/327

(57) ABSTRACT

The invention is a method and system for increasing the comfort of musicians as they play an instrument. In one aspect, the invention relates to facilitating in the correction positioning of a musical instrument. In particular, the invention relates to supporting a banjo. In another aspect of improving comfort, the areas of metal finger picks that will contact the upper portion of the finger, between the nail and the last knuckle, are coated with a cushioning material.

### CROSS-REFERENCE TO RELATED APPLICATIONS

This application claims the benefit of U.S. Provisional Application Ser. No. 60/736,160, filed Oct. 14, 2005, which is incorporated herein by reference.

### BACKGROUND OF THE INVENTION

1. Field of the Invention

This invention generally relates to a method and system for increasing the comfort of musicians as they play an instrument. In one aspect, the invention relates to facilitating in the correction positioning of a musical instrument. In particular, the invention relates to supporting a banjo. In another aspect of improving comfort, the areas of metal finger picks that will contact the upper portion of the finger, between the nail and the last knuckle, are coated with a cushioning material.

2. Background

A musical instrument is generally held in the hands of a musician. Holding the instrument in the correct alignment is essential for the musician to play properly and without undue fatigue. Stringed instruments, such as the banjo, are typically or strummed with the right hand while strings are “noted” with fingers of the left hand. Different chords are obtained by noting certain strings at certain locations along the neck of the banjo. A critical aspect for smooth playing is that the neck not be support by the left hand, since the left hand must be free to move along the neck for forming the chords of the song being played. However, the difficulty is that the neck of the banjo tends to rotate downwards due to the effect of gravity.

Currently, banjo players must master a technique of applying a downward force on the rim of the banjo with the right wrist. The downward force provides a frictional contact at the wrist-banjo contact point as well as along the lap-banjo contact point. However, the technique is difficult to learn. A complicating factor is that the rim and sounding board of a banjo are typically round and smooth, with a low coefficient of friction at the lap-banjo contact. The problem is particularly aggravating when the musician is wearing clothes made from fine material. The slipping of the banjo distracts the musician, who now must be concerned with maintaining the proper orientation of the neck. Therefore, there is a need for a method and system to assist in the proper support of the banjo.

Additionally, banjo players often wear metal finger picks to increase the volume of the played instrument. The picks are commonly made of relatively thin metal, and tabs from the picks are bent around the finger tips to hold the picks securely to the musician. When the strings are plucked, the tabs sometimes push uncomfortably on the top portion of the finger, just behind the finger nail. Therefore, there is a need for a improving the comfort of finger picks.

### BRIEF SUMMARY OF THE INVENTION

A device is described for increasing the coefficient of friction between an instrument's body and the clothes of the musician. In one embodiment, a mat fabricated from rubbery material is placed on the lab of the musician; the instrument is then placed on top of the mat. In another embodiment, a cylinder is fashioned from the rubbery material and stretched around the body of the instrument, much like a shower cap. The instrument is then held in the lap of the musician.

In another aspect of increasing musician comfort, a method is described for improving metal finger picks by applying a cushioning material to the areas of the picks in contact with the upper portion of the fingers.

### BRIEF DESCRIPTION OF THE SEVERAL VIEWS OF THE DRAWING

Not applicable.

### DETAILED DESCRIPTION OF THE INVENTION

The solution to increasing the coefficient of friction between the instrument and musician is supplied by a mat. A critical aspect of the invention is that the mat be fabricated from a non-slip material, such as Dycem non-slip mats from Dycem Limited, Warwick, R.I.—http::www.dycem-ns.com. In a preferred embodiment, an elliptical mat of a non-slip material with major and minor axis lengths of about 8 and 7 inches is used. Alternatively, the mat can be rectangular of approximately the same dimensions

In another embodiment, a cylinder with one or two open ends is fabricated with a diameter of about 14 inches and a wall height of about 2 inches. The cylinder is then stretched around the resonator of a banjo. This embodiment has the advantage of staying securely attached to the banjo, and will not fall off when the musician changes positions.

In yet another embodiment, a pocket is added to the material for storing accessories associated with playing the instrument, such as picks or tuners. This provides the advantage of keeping the accessories in close proximity to the instrument.

The solution to increasing musician comfort for wearing picks, the tabs of the picks are coated in a soft material. In a preferred embodiment, picks are manufactured in two stages. In the first stage, the metal pick is formed. In the second stage, a rubber-like coating is applied over the metal tabs, preferably in a dip process. One material suitable for the taks is commercially available as Plasti Dip (Plasti Dip International, Blaine, Minn.). After the coating cures, the metal pick can be bent to fit the particular size and shape of the musician's fingers.

In light of the above description, it is apparent that the present invention provides a method and system for increasing musician comfort. While the present invention has been described in the context of the banjo, the method and system described herein may be applied to other instruments.

I claim:

1. A method for improving the ease of holding an instrument comprising:
Obtaining non-slip material;
fashioning the non-slip material into a mat with size commensurate to the size of the instrument;
placing the fashioned material on the person holding the instrument; and
placing the instrument on the fashioned material.

2. The method of claim 1 where the mat is an ellipse with major and minor axes of approximately 8 and 7 inches.

3. The method of claim 1 where the mat is a rectangle with major and minor axes of approximately 8 and 7 inches.

4. The method of claim 1 wherein the instrument is one of a banjo, guitar, and mandolin.

5. The method of claim 1 further comprising fashioning at least one pocket into the material.

6. A method for improving the ease of holding a banjo comprising:
obtaining non-slip material;
fashioning the non-slip material into a cylinder with diameter commensurate with the diameter of the instrument; and
placing the fashioned material around the body of the instrument.

7. The method of claim 6 further comprising fashioning at least one pocket into the material.

8. The method of claim 6 wherein the cylinder has a wall height of approximately 2 inches and diameter of approximately 14 inches.

9. A method of increasing the comfort of a finger pick by coating in a cushioning material the areas of the pick that contact with the upper portion of the finger.

10. The method of claim 9 where the finger picks are metal.

11. The method of claim 9 where the finger picks are metal and the cushioning material is applied in a dipping process.

12. The method of claim 9 where the picks are manufactured with a larger than necessary span of the finger tabs, then coated with cushioning material.
